(19) United States
(12) Patent Application Publication
(10) Pub. No.: US 2024/0158605 A1
(43) Pub. Date: May 16, 2024

(54) ELASTOMER COMPOSITION AND METHOD OF PRODUCING SAME, CROSS-LINKED MATERIAL, AND SHAPED OBJECT

(71) Applicants: ZEON CORPORATION, Chiyoda-ku, Tokyo (JP); National Institute of Advanced Industrial Science and Technology, Chiyoda-ku, Tokyo (JP)

(72) Inventors: Yoshihisa TAKEYAMA, Chiyoda-ku, Tokyo (JP); Masahiro UENO, Chiyoda-ku, Tokyo (JP); Ryoichi KISHI, Chiyoda-ku, Tokyo (JP); Ken KOKUBO, Chiyoda-ku, Tokyo (JP); Takeo YAMADA, Chiyoda-ku, Tokyo (JP)

(73) Assignees: ZEON CORPORATION, Chiyoda-ku, Tokyo (JP); National Institute of Advanced Industrial Science and Technology, Chiyoda-ku, Tokyo (JP)

(21) Appl. No.: 18/549,167

(22) PCT Filed: Mar. 30, 2022
(86) PCT No.: PCT/JP2022/016296

§ 371 Date: Sep. 6, 2023

(30) Foreign Application Priority Data
Mar. 30, 2021 (JP) 2021-058330

(51) Int. Cl. C08K 3/04; C08J 3/205

(52) U.S. Cl. CPC C08K 3/041; C08J 3/2053; C08J 2327/16; C08K 2201/011

(57) ABSTRACT

An elastomer composition contains a solvent in a proportion of not less than 1 part by mass and less than 60 parts by mass per 100 parts by mass of an elastomer. The solvent includes an organic solvent A having high affinity with carbon nanotubes and having a boiling point of 200° C. or lower and an organic solvent B having high affinity with the elastomer and having a boiling point of 200° C. or lower. The solvent results in the elastomer having a volume swelling degree of 150% or more and has a relative energy difference (RED^{CNT}) of 1.5 or less.

### TECHNICAL FIELD

The present disclosure relates to an elastomer composition, a method of producing an elastomer composition, a cross-linked material obtained through cross-linking of an elastomer composition, and a shaped object obtained through shaping.

### BACKGROUND

Elastomer compositions in which a carbon material is compounded with an elastomer are conventionally used as materials having excellent characteristics such as electrical conductivity, thermal conductivity, and strength. In recent years, carbon nanotubes (hereinafter, also abbreviated as “CNTs”) have attracted attention as carbon materials that are highly effective for improving the aforementioned characteristics.

Although CNTs have excellent characteristics individually, they have a high tendency to form bundles due to Van der Waals forces when used as a bulk material due to the small external diameter thereof. Therefore, when a shaped object is to be produced using an elastomer composition containing an elastomer and CNTs, it is desirable that bundle structures of the CNTs are disentangled and the CNTs are dispersed well in a matrix of the elastomer.

For this reason, Patent Literature (PTL) 1, for example, discloses kneading a composition that contains a polymer, CNTs, and an organic solvent such as methyl ethyl ketone in a carbon dioxide atmosphere that is in a subcritical state or a supercritical state. According to PTL 1, kneading of the composition in a carbon dioxide atmosphere that is in a subcritical state or a supercritical state enables good dispersion of the CNTs in a matrix of the polymer.

### CITATION LIST

Patent Literature

PTL 1: JP2018-203914A

### SUMMARY

### Technical Problem

However, in recent years, there has been demand for a new technique to even better disperse CNTs in an elastomer and efficiently produce a shaped object having various excellent characteristics.

Accordingly, an object of the present disclosure is to provide a new technique for efficiently producing an elastomer composition and a shaped object having good dispersion of carbon nanotubes in an elastomer.

### Solution to Problem

The inventors made extensive studies to achieve the foregoing object. The inventors made a new discovery that by compounding a specific amount of a solvent including at least two types of organic solvents that satisfy specific attributes as a solvent used in production of a CNT-containing elastomer composition and by selecting this solvent such that the volume swelling degree when the elastomer is caused to swell in the solvent is 150% or more, easy and good dispersion of the CNTs in the elastomer composition can be achieved, and ease of production can be increased in production of a shaped object using this elastomer composition. In this manner, the inventors completed the present disclosure.

Specifically, the present disclosure aims to advantageously solve the problem set forth above, and a presently disclosed elastomer composition comprises carbon nanotubes, an elastomer, and a solvent, wherein the solvent includes an organic solvent A having high affinity with the carbon nanotubes and having a boiling point of 200° C. or lower and an organic solvent B having high affinity with the elastomer and having a boiling point of 200° C. or lower, proportional content of the solvent is not less than 1 part by mass and less than 60 parts by mass per 100 parts by mass of the elastomer, the elastomer has a volume swelling degree in the solvent of 150% or more, and a relative energy difference (RED^{CNT}) of Hansen solubility parameters of the carbon nanotubes and the solvent is 1.5 or less. By compounding a specific amount of a solvent that includes at least two types of organic solvents satisfying specific attributes, that results in a volume swelling degree of 150% or more when the elastomer is caused to swell therein, and that has a RED^{CNT} value of 1.5 or less in this manner, it is possible to achieve easy and good dispersion of the carbon nanotubes in the elastomer and also to efficiently obtain a shaped object by using this elastomer composition.

Note that the term “boiling point” as used in the present specification refers to the boiling point at 1 atm.

Moreover, the “volume swelling degree” when an elastomer is caused to swell by a solvent can be measured by a method described in the EXAMPLES section.

Also note that a method for calculating the value of the relative energy difference (RED^{CNT}) of Hansen solubility parameters of carbon nanotubes and a solvent is described further below.

In the presently disclosed elastomer composition, a relative energy difference (RED^{E}) of Hansen solubility parameters of the elastomer and the solvent is preferably 2.0 or less. By using an elastomer composition in which a solvent having a value for RED^{E} that satisfies the specific condition set forth above is compounded, it is possible to obtain an elastomer composition having even better dispersion of CNTs in an elastomer.

Note that a method for calculating the value of the relative energy difference (RED^{E}) of Hansen solubility parameters of an elastomer and a solvent is described further below.

The presently disclosed elastomer composition preferably comprises not less than 0.1 parts by mass and not more than 10 parts by mass of the carbon nanotubes per 100 parts by mass of the elastomer. By using an elastomer composition having CNTs compounded in a proportion that is within the range set forth above relative to an elastomer, it is possible to obtain an elastomer composition having even better dispersion of CNTs in an elastomer and to cause a shaped object formed using this elastomer composition to sufficiently display expected characteristics (electrical conductivity, thermal conductivity, strength, etc.).

In the presently disclosed elastomer composition, the carbon nanotubes preferably include single-walled carbon nanotubes. By using an elastomer composition that contains single-walled CNTs as CNTs, it is possible to obtain a shaped object having even better characteristics such as electrical conductivity, thermal conductivity, and strength.

The presently disclosed elastomer composition can further comprise a cross-linker. By using an elastomer composition that contains a cross-linker, it is possible to obtain a shaped object as a cross-linked material excelling in terms of strength and the like.

Moreover, the present disclosure aims to advantageously solve the problem set forth above, and a presently disclosed method of producing an elastomer composition is a method of producing any one of the elastomer compositions set forth above, comprising mixing and dispersing a material containing the carbon nanotubes, the elastomer, the organic solvent A, and the organic solvent B. Through the mixing and dispersing described above, it is possible to efficiently obtain an elastomer composition having good disentanglement of bundle structures of CNTs and to efficiently produce a shaped object having sufficiently good dispersion of CNTs in an elastomer by using this elastomer composition.

In the presently disclosed method of producing an elastomer composition, the mixing and dispersing can include: mixing the carbon nanotubes, the organic solvent A, and the organic solvent B to obtain a mixture; and mixing and dispersing the mixture that is obtained and the elastomer.

Furthermore, the present disclosure aims to advantageously solve the problem set forth above, and a presently disclosed cross-linked material is obtained through cross-linking of any one of the elastomer compositions set forth above. A cross-linked material obtained from any one of the elastomer compositions set forth above has excellent ease of production and has good dispersion of CNTs in an elastomer, thus providing the cross-linked material with excellent characteristics such as electrical conductivity, thermal conductivity, and strength.

Also, the present disclosure aims to advantageously solve the problem set forth above, and a presently disclosed shaped object comprises the cross-linked material set forth above. A shaped object that contains the cross-linked material set forth above has excellent ease of production and has good dispersion of CNTs in an elastomer, thus providing the shaped object with excellent characteristics such as electrical conductivity, thermal conductivity, and strength.

### Advantageous Effect

According to the present disclosure, it is possible to provide an elastomer composition that is capable of forming a shaped object having easy and good dispersion of carbon nanotubes in an elastomer and excellent ease of production, and it is also possible to provide a method of producing this elastomer composition.

Moreover, according to the present disclosure, it is possible to provide a cross-linked material and a shaped object having good dispersion of carbon nanotubes in an elastomer and excellent ease of production.

### DETAILED DESCRIPTION

The following provides a detailed description of embodiments of the present disclosure.

The presently disclosed elastomer composition can be used to produce the presently disclosed cross-linked material and shaped object. Moreover, the presently disclosed elastomer composition can be produced, for example, using the presently disclosed method of producing an elastomer composition.

(Elastomer Composition)

The presently disclosed elastomer composition contains an elastomer, CNTs, and a solvent and optionally further contains a cross-linker and additives.

The solvent that is compounded in the presently disclosed elastomer composition includes an organic solvent A having high affinity with the CNTs and having a boiling point of 200° C. or lower and an organic solvent B having high affinity with the elastomer and having a boiling point of 200° C. or lower. In addition, this solvent results in a volume swelling degree of 150% or more when the elastomer is caused to swell therein and has a value for relative energy difference (RED^{CNT}) of Hansen solubility parameters with the carbon nanotubes of 1.5 or less. Moreover, the proportion in which the solvent is compounded in the presently disclosed elastomer composition is not less than 1 part by mass and less than 60 parts by mass per 100 parts by mass of the elastomer. Although it is not clear why a shaped object having good dispersion of CNTs in an elastomer and excellent ease of production can be obtained by compounding a solvent that satisfies conditions such as set forth above, the reason for this is presumed to be as follows.

The organic solvent A that has high affinity with the CNTs can impregnate bundle structures of the CNTs and thereby promote disentanglement of the bundle structures. The same effect is promoted as a result of the relative energy difference (RED^{CNT}) of Hansen solubility parameters of the CNTs and the solvent (inclusive of the organic solvents A and B; hereinafter, the solvent including the organic solvents A and B is also referred to as a “mixed solvent” in description in the present specification) being 1.5 or less. This is because a lower value for the relative energy difference (RED^{CNT}) of Hansen solubility parameters of the CNTs and the mixed solvent indicates that the CNTs and the mixed solvent have higher affinity. It is also presumed that as a result of the organic solvent B having high affinity with the elastomer being present in the elastomer composition and as a result of the mixed solvent that includes the organic solvent A and the organic solvent B causing the elastomer to swell in a ratio with a volume swelling degree of 150% or more, it becomes easier to cause good dispersion of disentangled bundle structures in the elastomer composition. Moreover, it is presumed that as a result of the organic solvents A and B each having a boiling point of 200° C. or lower, it is not necessary to excessively increase the drying temperature when removing the organic solvents during production of a shaped object, and thus ease of production of a shaped object can be increased.

<Elastomer>

The elastomer may be any rubber, resin, or mixture thereof, for example, without any specific limitations. Since selection of the elastomer and the mixed solvent such that the volume swelling degree of the elastomer and the relative energy difference (RED^{CNT}) are within specific ranges is a fundamental principle for obtaining an effect of increasing dispersibility of the CNTs in the elastomer composition in the present disclosure, the type of elastomer is not specifically limited so long as these conditions are satisfied.

Specifically, the rubber may be natural rubber; fluororubber such as vinylidene fluoride rubber (FKM), tetrafluoroethylene-propylene rubber (FEPM), or tetrafluoroethylene-perfluoro vinyl ether rubber (FFKM); diene rubber such as butadiene rubber (BR), isoprene rubber (IR), styrene-butadiene rubber (SBR), hydrogenated styrene-butadiene rubber (H-SBR), nitrile rubber (NBR), or hydrogenated nitrile rubber (H-NBR); acrylic rubber (ACM, AEM); silicone rubber; or the like, for example, without any specific limitations.

Of the examples given above, the elastomer is preferably fluororubber such as vinylidene fluoride rubber (FKM), tetrafluoroethylene-propylene rubber (FEPM), or tetrafluoroethylene-perfluoro vinyl ether rubber (FFKM); nitrile rubber (NBR); and hydrogenated nitrile rubber (H-NBR), and the elastomer is more preferably FKM, FEPM, or H-NBR. By using an elastomer composition that contains at least any one of these elastomers, it is possible to obtain a shaped object having even better dispersion of CNTs in an elastomer.

Note that one of these elastomers can be used individually, or two or more of these elastomers can be used as a mixture.

<Carbon Nanotubes>

Although single-walled carbon nanotubes and/or multi-walled carbon nanotubes can be used as the CNTs without any specific limitations, the CNTs are preferably carbon nanotubes having from 1 to 5 walls, and are more preferably single-walled carbon nanotubes. This is because when single-walled CNTs are used, characteristics (for example, electrical conductivity, thermal conductivity, and strength) of a shaped object improve even with a small amount of the CNTs.

The average diameter of the CNTs is preferably 1 nm or more, and is preferably 60 nm or less, more preferably 30 nm or less, and even more preferably 10 nm or less. When the average diameter of the CNTs is within any of the ranges set forth above, characteristics (for example, electrical conductivity, thermal conductivity, and strength) of a shaped object can be sufficiently improved.

The “average diameter” of the CNTs referred to in the present disclosure can be determined by measuring the diameters (external diameters) of 20 CNTs, for example, in a transmission electron microscope (TEM) image, and then calculating a number-average value.

The CNTs are preferably CNTs for which a ratio (3σ/Av) of a value (3σ), which is obtained by multiplying the diameter standard deviation (σ: sample standard deviation) by 3, relative to the average diameter (Av) is more than 0.20 and less than 0.60, more preferably CNTs for which 3σ/Av is more than 0.25, and even more preferably CNTs for which 36/Av is more than 0.50. By using CNTs for which 3σ/Av is more than 0.20 and less than 0.60, it is possible to further improve characteristics (for example, electrical conductivity, thermal conductivity, and strength) of a shaped object.

Note that the average diameter (Av) and the standard deviation (σ) of the CNTs may be adjusted by changing the production method or production conditions of the CNTs, or may be adjusted by combining a plurality of types of CNTs obtained by different production methods.

The CNTs that are typically used take a normal distribution when a plot is made of diameter measured as described above on a horizontal axis and probability density thereof on a vertical axis, and a Gaussian approximation is made.

The average length of the CNTs is preferably 10 μm or more, more preferably 50 μm or more, and even more preferably 80 μm or more, and is preferably 600 μm or less, more preferably 550 μm or less, and even more preferably 500 μm or less. When the average length of the CNTs is within any of the ranges set forth above, characteristics (for example, electrical conductivity, thermal conductivity, and strength) of a shaped object can be sufficiently improved.

Note that the “average length” of the CNTs referred to in the present disclosure can be determined by measuring the lengths of 20 CNTs, for example, in a scanning electron microscope (SEM) image, and then calculating a number-average value.

The CNTs normally have an aspect ratio of more than 10. Note that the aspect ratio of the CNTs can be determined by measuring the diameters and lengths of 20 randomly selected CNTs using a scanning electron microscope or a transmission electron microscope and then calculating an average value of the ratio of diameter and length (length/diameter).

The BET specific surface area of the CNTs is preferably 600 m²/g or more, and more preferably 800 m²/g or more, and is preferably 2,000 m²/g or less, more preferably 1,800 m²/g or less, and even more preferably 1,600 m²/g or less. When the BET specific surface area of the CNTs is 600 m²/g or more, characteristics (for example, electrical conductivity, thermal conductivity, and strength) of a shaped object can be sufficiently enhanced with a small amount of the CNTs. Moreover, when the BET specific surface area of the CNTs is 2,000 m²/g or less, bundle structures of the CNTs can be disentangled well.

Herein, the term “BET specific surface area” refers to nitrogen adsorption specific surface area measured by the BET method.

A t-plot for the CNTs obtained from an adsorption isotherm preferably exhibits a convex upward shape. Note that a “t-plot” can be obtained by, in an adsorption isotherm of the CNTs measured by the nitrogen gas adsorption method, converting the relative pressure to an average thickness t (nm) of an adsorbed layer of nitrogen gas. Specifically, an average adsorbed nitrogen gas layer thickness t corresponding to a given relative pressure is determined from a known standard isotherm of average adsorbed nitrogen gas layer thickness t plotted against relative pressure P/PO, and the above-described conversion is made to obtain a t-plot for the CNTs (t-plot method of de Boer et al.).

Note that the CNTs for which a t-plot obtained from an adsorption isotherm exhibits a convex upward shape are preferably CNTs that have not undergone opening formation treatment.

In a substance having pores at its surface, the growth of the adsorbed layer of nitrogen gas is categorized into the following processes (1) to (3). The gradient of the t-plot changes in accordance with processes (1) to (3).

(1) A process in which a single molecule adsorption layer of nitrogen molecules is formed over the entire surface

(2) A process in which a multi-molecule adsorption layer is formed and is accompanied by capillary condensation filling of pores

(3) A process in which a multi-molecule adsorption layer is formed at a surface that appears to be non-porous due to the pores being filled by nitrogen

In a t-plot having a convex upward shape, the plot is on a straight line passing through the origin in a region in which the average adsorbed nitrogen gas layer thickness t is small, but, as t increases, the plot deviates downward from the straight line. When CNTs have a t-plot shape such as described above, this indicates that the CNTs have a large ratio of internal specific surface area relative to total specific surface area and that numerous openings are formed in constituent carbon nanostructures of the CNTs.

A bending point of the t-plot for the CNTs is preferably within a range of 0.2≤t (nm)≤1.5, more preferably within a range of 0.45≤t (nm)≤1.5, and even more preferably within a range of 0.55≤t (nm)≤1.0. When the bending point of the t-plot for the CNTs is within any of these ranges, characteristics (for example, electrical conductivity, thermal conductivity, and strength) of a shaped object can be enhanced with a small amount of the CNTs.

The “position of the bending point” is defined as an intersection point of a linear approximation A for the above-described process (1) and a linear approximation B for the above-described process (3).

A ratio (S2/S1) of internal specific surface area S2 of the CNTs relative to total specific surface area S1 of the CNTs determined from the t-plot is preferably not less than 0.05 and not more than 0.30. When the value of S2/S1 for the CNTs is within this range, characteristics (for example, electrical conductivity, thermal conductivity, and strength) of a shaped object can be enhanced with a small amount of the CNTs.

The total specific surface area S1 and the internal specific surface area S2 of the CNTs can be determined from the t-plot for the CNTs. Specifically, the total specific surface area S1 and external specific surface area S3 can first be determined from the gradient of the linear approximation of process (1) and the gradient of the linear approximation of process (3), respectively. The internal specific surface area S2 can then be calculated by subtracting the external specific surface area S3 from the total specific surface area S1.

Measurement of an adsorption isotherm of the CNTs, preparation of a t-plot, and calculation of the total specific surface area S1 and the internal specific surface area S2 based on t-plot analysis can be performed using a BELSORP®-mini (BELSORP is a registered trademark in Japan, other countries, or both), for example, which is a commercially available measurement apparatus produced by Bel Japan Inc.

The CNTs preferably have a radial breathing mode (RBM) peak when evaluated by Raman spectroscopy. Note that an RBM is not present in the Raman spectrum of multi-walled CNTs having three or more walls.

A ratio (G/D ratio) of G-band peak intensity relative to D-band peak intensity in a Raman spectrum of the CNTs is preferably not less than 0.5 and not more than 5.0. When the G/D ratio is not less than 0.5 and not more than 5.0, characteristics (for example, electrical conductivity, thermal conductivity, and strength) of a shaped object can be further improved.

The CNTs can be produced by a known CNT synthesis method such as arc discharge, laser ablation, or chemical vapor deposition (CVD) without any specific limitations. More specifically, the CNTs can be efficiently produced, for example, in accordance with a method in which, during synthesis of CNTs by chemical vapor deposition (CVD) by supplying a feedstock compound and a carrier gas onto a substrate having a catalyst layer for CNT production at the surface thereof, a trace amount of an oxidant (catalyst activating material) is provided in the system in order to dramatically improve the catalytic activity of the catalyst layer (super growth method; refer to WO2006/011655A1). Hereinafter, CNTs that are obtained by the super growth method are also referred to as “SGCNTs”.

CNTs that are produced by the super growth method may consist of only SGCNTs or may include other carbon nanostructures such as non-circular tube-shaped carbon nanostructures, for example, in addition to SGCNTs.

<<Amount of CNTs>>

The amount of CNTs in the elastomer composition is preferably 0.1 parts by mass or more, and more preferably 1 part by mass or more per 100 parts by mass of the elastomer, and is preferably 10 parts by mass or less, and more preferably 8 parts by mass or less per 100 parts by mass of the elastomer. By using an elastomer composition having the CNTs compounded in a proportion that is within the range set forth above relative to the elastomer, it is possible to obtain an elastomer composition and a shaped object having even better dispersion of the CNTs in the elastomer and to cause the shaped object to sufficiently display expected characteristics (electrical conductivity, thermal conductivity, strength, etc.).

<Solvent>

The constituent solvent of the elastomer composition includes an organic solvent A satisfying specific attributes and an organic solvent B satisfying specific attributes. Note that the organic solvent A and the organic solvent B are solvents that differ from each other and that the solvent at least includes these at least two types of organic solvents. Moreover, the solvent is required to result in the elastomer having a volume swelling degree of 150% or more. Furthermore, the relative energy difference (RED^{CNT}) of Hansen solubility parameters of the carbon nanotubes and the solvent is required to be 1.5 or less.

<<Volume Swelling Degree of Elastomer>>

The volume swelling degree when the elastomer is caused to swell in the solvent (mixed solvent) is required to be 150% or more, and is preferably 200% or more, and more preferably 220% or more. When the volume swelling degree is not less than any of the lower limits set forth above, dispersibility of the CNTs in the elastomer composition and in an obtained shaped object can be even further increased.

No specific limitations are placed on the upper limit for the volume swelling degree. In other words, the elastomer may be in a dissolved state in the solvent rather than just being caused to swell by the solvent. In the present specification, the degree of swelling (by volume) of the elastomer that results from one month of immersion of the elastomer in the solvent is evaluated as the volume swelling degree as described in the EXAMPLES section. In a case in which the elastomer is in a dissolved state in the solvent in this evaluation method, the swelling degree of the elastomer in the solvent is interpreted to be infinite. In other words, the combination of elastomer and solvent that is adopted in the present disclosure can be any combination with the exception of cases in which the volume swelling degree of the elastomer in the solvent is less than 150%.

<<Relative Energy Difference (RED^{CNT})>>

The relative energy difference (RED^{CNT}) of Hansen solubility parameters of the carbon nanotubes and the mixed solvent is required to be 1.5 or less, and is preferably 1.2 or less, and more preferably 1.0 or less. When the value of the relative energy difference (RED^{CNT}) is not more than any of the upper limits set forth above, dispersibility of the CNTs in the elastomer composition and in an obtained shaped object can be even further increased. Note that no specific limitations are placed on the lower limit for the value of the relative energy difference (RED^{CNT}) and the value thereof can be 0 or more, for example.

The value of the relative energy difference (RED^{CNT}) can be calculated according to the following procedures 1 to 3.

(1) Procedure 1: Calculation of Hansen solubility parameters (HSPs) of solvent

HSP values of the solvent (mixed solvent) including the solvent A and the solvent B are calculated by the following formula (1) as average values weighted in accordance with volume ratios of the solvents A and B in the mixed solvent.

[dDm,dPm,dHm]=[(a×dD1+b×dD2),(a×dP1+b×dP2),(a×dH1+b×dH2)]/(a+b) (1)

In the preceding formula:
dDm indicates energy originating from dispersive force between molecules of solvent;
dPm indicates energy originating from polar force between molecules of solvent;
dHm indicates energy originating from hydrogen bond force between molecules of solvent;
dD1 indicates energy originating from dispersive force between molecules of solvent A;
dP1 indicates energy originating from polar force between molecules of solvent A;
dH1 indicates energy originating from hydrogen bond force between molecules of solvent A;
dD2 indicates energy originating from dispersive force between molecules of solvent B;
dP2 indicates energy originating from polar force between molecules of solvent B;
dH2 indicates energy originating from hydrogen bond force between molecules of solvent B;
a indicates volume ratio of solvent A in solvent; and
b indicates volume ratio of solvent B in solvent.

Note that the definition and calculation method of Hansen solubility parameters (MPa^{1/2}) are described in the following document: Charles M. Hansen; Hansen Solubility Parameters: A User's Handbook; CRC Press; 2007.

Moreover, in the case of a substance for which literature values for Hansen solubility parameters are unknown, it is simple to estimate the Hansen solubility parameters from the chemical structure of the substance using the computer software “Hansen Solubility Parameters in Practice (HSPiP)”.

More specifically, using HSPiP Version 3, for example, recorded values may be used in the case of a substance that is recorded in the database, and estimated values may be used in the case of a substance that is not recorded.

(2) Procedure 2: Calculation of distance between HSP values

Values for the distance Rac NT between HSP values of the CNTs and the solvent (mixed solvent) and the distance Ra E between HSP values of the elastomer and the solvent (mixed solvent) are calculated based on the following formula (2).

(Ra)²=4(dD2−dD1)²+(dP2−dP1)²+(dH2−dH1)² (2)

In the preceding formula (2):
dD1 indicates energy originating from dispersive force between molecules of CNTs or elastomer;
dP1 indicates energy originating from polar force between molecules of CNTs or elastomer;
dH1 indicates energy originating from hydrogen bond force between molecules of CNTs or elastomer;
dD2 indicates energy originating from dispersive force between molecules of solvent (mixed solvent);
dP2 indicates energy originating from polar force between molecules of solvent; and
dH2 indicates energy originating from hydrogen bond force between molecules of solvent.

Note that with regards to dD1, dP1, and dH1, values for the CNTs are substituted into the formula in a case in which the distance Ra^{CNT} between HSP value of the CNTs and the solvent (mixed solvent) is to be calculated, whereas values for the elastomer are substituted into the formula in a case in which the distance Ra^{E} between HSP values of the elastomer and the solvent (mixed solvent) is to be calculated.

(3) Calculation of relative energy difference

The relative energy difference can be calculated according to the following formula (3). Note that the interaction radius R0^{CNT} of the CNTs and the interaction radius R0^{E} of the elastomer can be calculated based on experimentation measuring solubility with respect to a solvent for which HSP values are known and simulation using the Sphere function of HSPiP, for example.

(RED)=Ra/R0 (3)

In the preceding formula (3), Ra is a value for Ra^{CNT} or Ra^{E} that has been calculated in the above-described step. A value for Ra^{CNT} is substituted into the formula in a case in which the relative energy difference (RED^{CNT}) of Hansen solubility parameters of the CNTs and the solvent is to be calculated, whereas a value for Ra^{E} is substituted into the formula in a case in which the relative energy difference (RED^{E}) of Hansen solubility parameters of the elastomer and the solvent is to be calculated.

A value for the interaction radius R0^{CNT} of the CNTs is substituted into the formula as a value for R0 in a case in which RED^{CNT} is to be calculated, whereas a value for the interaction radius R0^{E} of the elastomer is substituted into the formula as a value for R0 in a case in which RED^{E} is to be calculated.

<<Relative Energy Difference (RED^{E})>>

The relative energy difference (RED^{E}) of Hansen solubility parameters of the elastomer and the solvent (mixed solvent) is preferably 2.0 or less, more preferably 1.9 or less, and even more preferably 1.8 or less. When the value of the relative energy difference (RED^{E}) is not more than any of the upper limits set forth above, di spersibility of the CNTs in the elastomer composition and in an obtained shaped object can be even further increased. Note that no specific limitations are placed on the lower limit for the value of the relative energy difference (RED^{E}) and the value thereof can be 0 or more, for example.

<<Organic Solvent A>>

The organic solvent A is an organic solvent having high affinity with the CNTs and having a boiling point of 200° C. or lower. Note that the phrase “high affinity with the CNTs” means that a small value is obtained when calculating the relative energy difference (RED^{A-CNT}) of Hansen solubility parameters of the CNTs and the organic solvent A. For example, the value of the relative energy difference (RED^{A-CNT}) is preferably 1.1 or less, and more preferably 1.0 or less.

The value of the relative energy difference (RED^{A-CNT}) can be calculated by the same procedures as the previously described procedures (1) to (3).

The boiling point of the organic solvent A is required to be 200° C. or lower, and is preferably 180° C. or lower, and more preferably 170° C. or lower. The lower limit for the boiling point of the organic solvent A is not specifically limited but is preferably 100° C. or higher, more preferably 120° C. or higher, and even more preferably 150° C. or higher. When the boiling point of the organic solvent A is not higher than any of the upper limits set forth above, it is not necessary to excessively increase the drying temperature in production of a shaped object, and thus production efficiency is excellent. Moreover, when the boiling point of the organic solvent A is not lower than any of the lower limits set forth above, excessive vaporization of the organic solvent A does not occur when obtaining the elastomer composition and a shaped object, and the CNTs can be dispersed well in the elastomer in a shaped object that is obtained from the elastomer composition.

An organic compound that includes an aromatic ring can be used without any specific limitations as the organic solvent A. More specifically, the organic solvent A may be toluene or a derivative thereof (for example, toluene, p-chlorotoluene, o-chlorotoluene, or p-bromotoluene), or may be a derivative of benzene such as 1,2,4-trimethylbenzene. One of these organic solvents can be used individually, or two or more of these organic solvents can be used as a mixture. The organic solvent A is presumed to facilitate disentanglement of bulk structures as a result of having excellent affinity with the CNTs. Accordingly, the inclusion of the organic solvent A in the mixed solvent makes it possible to cause even better dispersion of the CNTs in the elastomer in the elastomer composition and in an obtained shaped object.

—Proportional Content of Organic Solvent A—

The proportional content of the organic solvent A in the mixed solvent is not specifically limited so long as the mixed solvent satisfies the previously described conditions relating to the “volume swelling degree of the elastomer” and the “relative energy difference (RED^{CNT})”. For example, when the overall volume of the mixed solvent (organic solvent A and organic solvent B) is taken to be 1, the proportional content of the organic solvent A in the mixed solvent is preferably a volume fraction of 0.40 or more, and more preferably a volume fraction of 0.50 or more, and is preferably a volume fraction of 0.90 or less, and more preferably a volume fraction of 0.80 or less. When the proportional content of the organic solvent A in the mixed solvent is within any of the ranges set forth above, it is possible to cause even better dispersion of the CNTs in the elastomer in the elastomer composition and in an obtained shaped object.

<<Organic Solvent B>>

The organic solvent B is an organic solvent having high affinity with the elastomer and having a boiling point of 200° C. or lower. Note that the phrase “high affinity with the elastomer” means that a small value is obtained when calculating the relative energy difference (RED^{B-E}) of Hansen solubility parameters of the elastomer and the organic solvent B. For example, the value of the relative energy difference (RED^{B-E}) is preferably 2.0 or less, and more preferably 1.7 or less.

The value of the relative energy difference (RED^{B-E}) can be calculated by the previously described procedures (1) to (3).

The boiling point of the organic solvent B is required to be 200° C. or lower, and is preferably 180° C. or lower, and more preferably 170° C. or lower. The lower limit for the boiling point of the organic solvent B is not specifically limited but is preferably 100° C. or higher, more preferably 120° C. or higher, and even more preferably 145° C. or higher. When the boiling point of the organic solvent B is not higher than any of the upper limits set forth above, it is not necessary to excessively increase the drying temperature in production of a shaped object, and thus production efficiency is excellent. Moreover, when the boiling point of the organic solvent B is not lower than any of the lower limits set forth above, excessive vaporization of the organic solvent B does not occur when obtaining the elastomer composition and a shaped object, and the CNTs can be dispersed well in the elastomer in a shaped object that is obtained from the elastomer composition.

Ketones, amides, ethers, and esters can be used without any specific limitations as the organic solvent B. More specifically, the organic solvent B may be methyl ethyl ketone, methyl isobutyl ketone, N,N-dimethylformamide, N,N-dimethylacetamide, N,N-diethylformamide, tetrahydrofuran, 1,4-dioxane, ethyl acetate, butyl acetate, or amyl acetate. One of these organic solvents can be used individually, or two or more of these organic solvents can be used as a mixture. The organic solvent B has excellent affinity with the elastomer and thus functions to cause impregnation of the elastomer into gaps in bulk structures that have been disentangled through the action of the organic solvent A. As a result, the CNTs can be even better dispersed in the elastomer in the elastomer composition and in an obtained shaped object.

—Proportional Content of Organic Solvent B—

The proportional content of the organic solvent B in the mixed solvent is not specifically limited so long as the mixed solvent satisfies the previously described conditions relating to the “volume swelling degree of the elastomer” and the “relative energy difference (RED^{CNT})”. For example, when the overall volume of the mixed solvent (organic solvent A and organic solvent B) is taken to be 1, the proportional content of the organic solvent B in the mixed solvent is preferably a volume fraction of 0.10 or more, and more preferably a volume fraction of 0.20 or more, and is preferably a volume fraction of 0.60 or less, and more preferably a volume fraction of 0.50 or less. When the proportional content of the organic solvent B in the mixed solvent is within any of the ranges set forth above, the CNTs can be even better dispersed in the elastomer in the elastomer composition and in an obtained shaped object.

<<Proportion of Mixed Solvent>>

The proportional content of the mixed solvent per 100 parts by mass of the elastomer is required to be not less than 1 part by mass and less than 60 parts by mass, is preferably 10 parts by mass or more, more preferably 20 parts by mass or more, and even more preferably 30 parts by mass or more, and is preferably 55 parts by mass or less, and more preferably 50 parts by mass or less. When the proportional content of the mixed solvent per 100 parts by mass of the elastomer is within any of the ranges set forth above, the CNTs can be even better dispersed in the elastomer in the elastomer composition and in an obtained shaped object.

<Cross-Linker>

Any known cross-linker that can cross-link the elastomer in the elastomer composition set forth above can be used without any specific limitations as a cross-linker that is optionally contained in the presently disclosed elastomer composition. Examples of such cross-linkers include sulfuric cross-linkers, peroxide-based cross-linkers, bisphenol-based cross-linkers, and diamine-based cross-linkers.

Note that one cross-linker can be used individually, or two or more cross-linkers can be used as a mixture.

The content of the cross-linker in the elastomer composition can be set as an amount that is typically used in a known elastomer composition without any specific limitations.

<Additives>

Examples of additives that can be used include, but are not specifically limited to, dispersants, antioxidants, heat stabilizers, light stabilizers, ultraviolet absorbers, pigments, colorants, foaming agents, antistatic agents, flame retardants, lubricants, softening agents, tackifiers, plasticizers, mold release agents, deodorants, and perfumes.

More specifically, carbon black, silica, talc, barium sulfate, calcium carbonate, clay, magnesium oxide, calcium hydroxide, or the like, for example, may be used as an additive.

Note that one additive can be used individually, or two or more additives can be used as a mixture.

The content of additives in the elastomer composition can be set as an amount that is typically used in a known elastomer composition without any specific limitations. For example, the content of additives in the elastomer composition can be set as not less than 5 parts by mass and not more than 40 parts by mass per 100 parts by mass of the elastomer.

(Method of Producing Elastomer Composition)

The presently disclosed elastomer composition set forth above can be produced by the presently disclosed method of producing an elastomer composition, for example. The presently disclosed method of producing an elastomer composition includes a step of mixing and dispersing a material containing the CNTs, the elastomer, the organic solvent A, and the organic solvent B. Note that the presently disclosed method of producing an elastomer composition may also include steps other than the step described above. For example, the presently disclosed production method may include a preparation step of mixing the organic solvent A and the organic solvent B in a specific mixing ratio to prepare a mixed solvent as a solvent in advance of the step described above.

Through the presently disclosed method of producing an elastomer composition, mixing and dispersing treatment is performed with respect to a material that contains the elastomer, the CNTs, the organic solvent A, and the organic solvent B, thereby enabling disentanglement of bundle structures of the CNTs and good dispersion of the CNTs in the elastomer. Moreover, as a result of the organic solvent A and the organic solvent B each having a boiling point of 200° C. or lower, it is comparatively easy to remove these organic solvents in production of a shaped object using an elastomer composition obtained in accordance with the present disclosure, resulting in excellent ease of production of the shaped object.

In the step of mixing and dispersing, the material that contains the CNTs, the elastomer, the organic solvent A, and the organic solvent B is mixed and dispersed to obtain an elastomer composition. No specific limitations are placed on the order of addition in the step of mixing and dispersing so long as an elastomer composition containing the CNTs, the elastomer, the organic solvent A, and the organic solvent B is ultimately obtained. For example, the step of mixing and dispersing can include a step of mixing the CNTs, the organic solvent A, and the organic solvent B to obtain a mixture and a step of mixing and dispersing the mixture that is obtained and the elastomer. Alternatively, the step of mixing and dispersing may, for example, include a step of mixing one portion of the CNTs obtained by dividing the used CNTs into two portions in a specific ratio (for example, 50:50) with the organic solvent A to obtain a mixture A, a step of mixing the other portion of the CNTs with the organic solvent B to obtain a mixture B, and a step of adding the mixture A and the mixture B to the elastomer and performing kneading thereof. By mixing the CNTs with a solvent in advance of mixing of the elastomer in this manner, it is easier for the solvent to impregnate the CNTs and cause disentanglement of bundle structures of the CNTs, and thus bundle structures of the CNTs can be disentangled well while also causing even better dispersion of the CNTs in the elastomer when mixing and dispersing are performed.

Note that in the step of mixing and dispersing, another organic solvent C having different attributes from the above-described organic solvents A and B, a cross-linker, and/or an additive may optionally be compounded in the material depending on the use of an elastomer composition and shaped object.

Note that mixing of CNTs with an organic solvent can be performed by any mixing method such as immersion of the CNTs in the organic solvent, impregnation of the CNTs with the organic solvent, application of the organic solvent onto the CNTs, or spraying of the organic solvent onto the CNTs, for example, without any specific limitations. In particular, from a viewpoint of enabling even better dispersion of the CNTs in an elastomer composition, it is preferable that the CNTs and the organic solvent are mixed through impregnation of the CNTs with the organic solvent.

Although the time for which impregnation of the CNTs with the organic solvent is performed in the step of mixing and dispersing can be any time, the impregnation time is preferably at least 1 hour, and more preferably at least 10 hours from a viewpoint of enabling better dispersion of the CNTs in an elastomer composition.

The temperature during impregnation of the CNTs with the organic solvent is also not specifically limited and can be set as a temperature that is not lower than the freezing point of the organic solvent but lower than the boiling point of the organic solvent at that pressure, for example. Note that the freezing point and the boiling point of an organic solvent can be determined by differential scanning calorimetry, for example.

Also note that impregnation of the CNTs with the organic solvent is normally performed at standard pressure (1 atm), but is not specifically limited thereto.

Any known dispersing treatment can be adopted as the dispersing method in the step of mixing and dispersing so long as it enables dispersion of the CNTs in the elastomer. Such dispersing treatment may, for example, be dispersing treatment through shear stress, dispersing treatment through impact energy, or dispersing treatment resulting in a cavitation effect.

Examples of devices that can be used to perform dispersing treatment through shear stress include a two-roll mill and a three-roll mill.

Examples of devices that can be used to perform dispersing treatment through impact energy include a bead mill and a rotor/stator-type disperser.

Examples of devices that can be used to perform dispersing treatment resulting in a cavitation effect include a jet mill and an ultrasonic disperser.

The conditions of the dispersing treatment are not specifically limited and can be set as appropriate within the range of dispersing conditions typically adopted in the above-described devices, for example.

(Cross-Linked Material)

The presently disclosed cross-linked material is obtained through cross-linking of the presently disclosed elastomer composition set forth above. The presently disclosed cross-linked material can be formed by performing a cross-linking reaction of the presently disclosed elastomer composition through heating, for example. The cross-linking temperature is normally 100° C. to 250° C., preferably 130° C. to 220° C., and more preferably 150° C. to 200° C., and the cross-linking time is normally 0.1 minutes to 10 hours, and preferably 1 minute to 5 hours. A method that is used in rubber cross-linking such as press heating, steam heating, oven heating, or hot air heating may be selected as appropriate as the heating method.

(Shaped Object)

The presently disclosed shaped object contains the presently disclosed cross-linked material set forth above. The presently disclosed shaped object may be a belt, a hose, a gasket, a packing, or an oil seal, for example, without any specific limitations.

The presently disclosed shaped object has excellent characteristics such as electrical conductivity, thermal conductivity, and strength as a result of having good dispersion of the CNTs in the elastomer.

Note that cross-linking and shaping of the elastomer composition are not specifically limited and can be implemented by performing a cross-linking reaction described in the “Cross-linked material” section during or after shaping of the elastomer composition by any shaping method such as injection molding, extrusion molding, press forming, or roll forming, for example, to produce a shaped object of a cross-linked material.

### EXAMPLES

The following provides a more detailed description of the present disclosure through examples. However, the present disclosure is not limited to these examples.

Various measurements and evaluations in the examples and comparative examples were performed as follows.

Volume Swelling Degree of Elastomer

Vinylidene fluoride rubber (Viton® GBL600S (Viton is a registered trademark in Japan, other countries, or both) produced by the Chemours Company) as an elastomer that had been cut to a size of 3 mm to 4 mm-square was measured out in an amount of 0.37 g and was transferred into a cell. A value of 0.2 cm³ obtained by dividing the aforementioned mass by the specific gravity (1.84 g/cm³) of the elastomer was taken to be the pre-swelling rubber volume (V0). Next, 3.6 mL of a mixed solvent of the composition used in each example or comparative example was added into the cell, and the cell was left at room temperature for 1 month to cause swelling of the elastomer. The height of the swollen product inside the cell was measured, and the volume V of the swollen product was calculated by the following formula (1).

V=Optical path width of cell×Optical path length of cell×Height of swollen product=1×1×Height of swollen product(cm³) (1)

The swollen product volume V in each mixed solvent was divided by the pre-swelling rubber volume V0 to calculate the swelling degree as V/V0×100(%).

<Relative Energy Difference (RED)>

A value for each type of relative energy difference was calculated by the previously described procedures (1) to (3).

<Kneadability>

In each example or comparative example, an evaluation of A was given in a case in which kneading could be performed and an evaluation of B was given in a case in which kneading could not be performed due to, for example, inability to wrap the elastomer around a roll.

<Dispersibility of CNTs>

The dispersion state of CNTs in an elastomer composition was evaluated by measuring the surface resistivity of a masterbatch as described below.

A low resistivity meter (produced by Mitsubishi Chemical Analytech Co., Ltd.; product name: Loresta-GP) was used to measure the surface resistivity of a masterbatch produced in each example or comparative example. The time at which the surface resistivity decreased to a substantially constant value in accompaniment to kneading time was taken to be the “kneading time until resistance value is constant”, and the minimum surface resistivity that was reached was taken to be the “surface resistance value”. A shorter “kneading time until resistance value is constant” indicates that a shorter time is required to cause good dispersion of CNTs in an elastomer composition. Moreover, a smaller value for the “surface resistance value” indicates that there is better dispersion of CNTs in an elastomer composition and that the CNTs will also have a better dispersion state in an obtained shaped object.

<Drying Conditions of Shaped Object>

With regards to evaluation of drying conditions of a shaped object, which can contribute to ease of production of the shaped object, a judgment of “harsh” necessitating the adoption of drying conditions exceeding 200° C. was made in a case in which the highest boiling point among boiling points of organic solvents contained in an elastomer composition exceeded 200° C.

A: Excellent production efficiency with drying possible under drying conditions of 200° C. or lower

B: Harsh with drying conditions exceeding 200° C. necessary

### Example 1

<Preparation Step>

A p-chlorotoluene/N,N-dimethylacetamide mixed solution (mixed solvent) having a volume ratio of 75:25 was prepared by adding 11.5 parts by mass (12.2 parts by volume) of N,N-dimethylacetamide (DMAc) as an organic solvent B to 38.5 parts by mass (36 parts by volume) of p-chlorotoluene (p-CT) as an organic solvent A.

<Step of Mixing and Dispersing>

Next, 40 parts by mass of the obtained mixed solvent was added to 4 parts by mass of carbon nanotubes (ZEONANO SG101 produced by Zeon Corporation; average diameter: 3.5 nm; BET specific surface area: 1,428 m²/g), and was subsequently held at 40° C. for 15 hours so as to cause sufficient impregnation and produce wet carbon nanotubes as a mixture.

The wet carbon nanotubes obtained as a mixture as described above and 100 parts by mass of vinylidene fluoride rubber (Viton® GBL600S produced by the Chemours Company) as an elastomer were subjected to dispersing treatment through kneading at room temperature using a two-roll mill so as to produce a masterbatch as an elastomer composition.

The obtained masterbatch was subjected to evaluations as previously described. The results are shown in Table 1.

### Example 2

Operations and evaluations were performed in the same way as in Example 1 with the exception that amyl acetate (AmAc) was used instead of N,N-dimethylacetamide (DMAc) as an organic solvent B and amounts were adjusted such that the volume ratio of organic solvent A:organic solvent B was 55:45 in the preparation step, and that the additive amount of the mixed solvent was adjusted such that the amount of the mixed solvent per 100 parts by mass of the elastomer was 40 parts by mass in the step of mixing and dispersing. The results are shown in Table 1.

### Example 3

Operations and evaluations were performed in the same way as in Example 1 with the exception that o-chlorotoluene (o-CT) was used instead of p-chlorotoluene (p-CT) as an organic solvent A and amounts were adjusted such that the volume ratio of organic solvent A:organic solvent B was 70:30 in the preparation step, and that the additive amount of the mixed solvent was adjusted such that the amount of the mixed solvent per 100 parts by mass of the elastomer was 40 parts by mass in the step of mixing and dispersing. The results are shown in Table 1.

### Example 4

Operations and evaluations were performed in the same way as in Example 1 with the exception that 1,2,4-trimethylbenzene (TMB) was used instead of p-chlorotoluene (p-CT) as an organic solvent A and amounts were adjusted such that the volume ratio of organic solvent A:organic solvent B was 70:30 in the preparation step, and that the additive amount of the mixed solvent was adjusted such that the amount of the mixed solvent per 100 parts by mass of the elastomer was 40 parts by mass in the step of mixing and dispersing. The results are shown in Table 1.

Note that in evaluation of the volume swelling degree as previously described in this example, the elastomer was confirmed to be in a dissolved state in the mixed solvent.

### Comparative Example 1

Operations and evaluations were performed in the same way as in Example 1 with the exception that amounts were adjusted such that the volume ratio of organic solvent A:organic solvent B was 30:70 in the preparation step, and that the additive amount of the mixed solvent was adjusted such that the amount of the mixed solvent per 100 parts by mass of the elastomer was 40 parts by mass in the step of mixing and dispersing. The results are shown in Table 1.

Note that in evaluation of the volume swelling degree as previously described in this example, the elastomer was confirmed to be in a dissolved state in the mixed solvent.

### Comparative Example 2

Operations and evaluations were attempted in the same way as in Example 1 with the exception that p-bromotoluene (p-BT) was used instead of p-chlorotoluene (p-CT) as an organic solvent A and amounts were adjusted such that the volume ratio of organic solvent A:organic solvent B was 99:1 in the preparation step. However, it was not possible to evaluate dispersibility and ease of dispersion. The results are shown in Table 1.

Note that in evaluation of the volume swelling degree as previously described in this example, there was confirmed to be absolutely no swelling (volume swelling degree: 100%).

### Comparative Example 3

Operations were performed in the same way as in Example 1 with the exception that the additive amount of the mixed solvent was adjusted such that the amount of the mixed solvent per 100 parts by mass of the elastomer was 60 parts by mass in the step of mixing and dispersing. However, with regards to evaluations, ease of dispersion could not be evaluated, and evaluation relating to drying of a shaped object was not performed. The results are shown in Table 1.

### Comparative Example 4

Operations and evaluations were performed in the same way as in Example 1 with the exception that methyl p-toluate (MMB) was used instead of p-chlorotoluene (p-CT) as an organic solvent A and a component corresponding to an organic solvent B was not compounded in the preparation step, and that the additive amount of the organic solvent A was adjusted such that the amount of the organic solvent A per 100 parts by mass of the elastomer was 40 parts by mass in the step of mixing and dispersing. The results are shown in Table 1.

### Comparative Example 5

A masterbatch was produced by adding 4 parts by mass of the CNTs to 100 parts by mass of the elastomer and then performing dispersing treatment thereof through kneading at room temperature using a two-roll mill without performing a preparation step and without using a solvent.

Evaluations of the obtained masterbatch were attempted in the same way as in Example 1. However, it was not possible to evaluate dispersibility and ease of dispersion. The results are shown in Table 1.

In Table 1:
“p-CT” indicates p-chlorotoluene;
“o-CT” indicates o-chlorotoluene;
“MMB” indicates methyl p-toluate;
“p-BT” indicates p-bromotoluene;
“DMAc” indicates N,N-dimethylacetamide;
“AmAc” indicates amyl acetate; and
“TMB” indicates 1,2,4-trimethylbenzene.

TABLE 1

| | | | | | | | Com- | Com- | Com- | Com- | Com- |
|---|---|---|---|---|---|---|---|---|---|---|---|
| | | | | | | | parative | parative | parative | parative | parative |
| | | | Ex- | Ex- | Ex- | Ex- | Ex- | Ex- | Ex- | Ex- | Ex- |
| | | | ample | ample | ample | ample | ample | ample | ample | ample | ample |
| | | | 1 | 2 | 3 | 4 | 1 | 2 | 3 | 4 | 5 |
| Elastomer | Type | | Fluororubber | | | | Fluororubber | | | | |
| | Amount [parts by mass] | | 100 | 100 | 100 | 100 | 100 | 100 | 100 | 100 | 100 |
| Mixed | Organic | Type | p-CT | p-CT | o-CT | TMB | p-CT | p-BT | p-CT | MMB | — |
| solvent | solvent | Boiling point [° C.] | 162 | 162 | 159 | 169 | 162 | 184 | 162 | 223 | — |
| | A | Volume fraction [−] | 0.75 | 0.55 | 0.70 | 0.70 | 0.30 | 0.99 | 0.75 | 1.00 | — |
| | | Relative energy difference | 0.6 | 0.6 | 0.6 | 1.1 | 0.6 | 0.6 | 0.6 | — | — |
| | | (RED^{A-CNT}) | | | | | | | | | |
| | Organic | Type | DMAc | AmAc | DMAc | DMAc | DMAc | DMAc | DMAc | — | — |
| | solvent | Boiling point [° C.] | 165 | 149 | 165 | 165 | 165 | 165 | 165 | — | — |
| | B | Volume fraction [−] | 0.25 | 0.45 | 0.30 | 0.30 | 0.70 | 0.01 | 0.25 | — | — |
| | | Relative energy difference | 1.7 | 1.0 | 1.7 | 1.7 | 1.7 | 1.7 | 1.7 | — | — |
| | | (RED^{B-E}) | | | | | | | | | |

| | | | | | | | | | | |
|---|---|---|---|---|---|---|---|---|---|---|
| | Amount of mixed solvent [phr; by mass] | 40 | 40 | 40 | 40 | 40 | 40 | 60 | 40 | — |
| Parameters | Relative energy difference (RED^{CNT}) | 0.8 | 0.9 | 0.6 | 1.0 | 2.2 | 0.6 | 0.8 | 0.7 | — |
| | between CNTs and mixed solvent [−] | | | | | | | | | |
| | Relative energy difference (RED^{E}) | 1.7 | 1.4 | 1.6 | 1.2 | 1.4 | 2.2 | 1.7 | 1.6 | — |
| | between elastomer and mixed solvent [−] | | | | | | | | | |
| | Volume swelling degree | 278 | 211 | 384 | (Dis- | (Dis- | 100 | 278 | 278 | — |
| | (or dissolution state) [%] | | | | solved) | solved) | | | | |
| Evaluation | Kneadability | A | A | A | A | A | B | B | A | A |
| | Dispersibility: Surface | 9.5 | 3.0 × 10 | 1.1 × 10 | 2.1 × 10 | 1.7 × 10 | — | — | 1.8 × 10 | 1.0 × 10¹⁴ |
| | resistance value [Ω/sq.] | | | | | | | | | |
| | Ease of dispersion: Kneading time until | <1 | 8.4 | <1 | <1 | 33 | — | — | 16.9 | — |
| | resistance value is constant [min] | | | | | | | | | |
| | Drying conditions of shaped object | A | A | A | A | A | A | A | B (harsh) | — |

It can be seen from Table 1 that in Examples 1 to 4, it was possible to form a shaped object having easy and good dispersion of carbon nanotubes in an elastomer and excellent ease of production as compared to in Comparative Examples 1 to 5.

### INDUSTRIAL APPLICABILITY

According to the present disclosure, it is possible to provide an elastomer composition that is capable of forming a shaped object having easy and good dispersion of carbon nanotubes in an elastomer and excellent ease of production, and it is also possible to provide a method of producing this elastomer composition.

Moreover, according to the present disclosure, it is possible to provide a cross-linked material and a shaped object having good dispersion of carbon nanotubes in an elastomer and excellent ease of production.

1. An elastomer composition comprising carbon nanotubes, an elastomer, and a solvent, wherein
the solvent includes an organic solvent A having high affinity with the carbon nanotubes and having a boiling point of 200° C. or lower and an organic solvent B having high affinity with the elastomer and having a boiling point of 200° C. or lower,
proportional content of the solvent is not less than 1 part by mass and less than 60 parts by mass per 100 parts by mass of the elastomer,
the elastomer has a volume swelling degree in the solvent of 150% or more, and
a relative energy difference (RED^{CNT}) of Hansen solubility parameters of the carbon nanotubes and the solvent is 1.5 or less.

2. The elastomer composition according to claim 1, wherein a relative energy difference (RED^{E}) of Hansen solubility parameters of the elastomer and the solvent is 2.0 or less.

3. The elastomer composition according to claim 1, comprising not less than 0.1 parts by mass and not more than 10 parts by mass of the carbon nanotubes per 100 parts by mass of the elastomer.

4. The elastomer composition according to claim 1, wherein the carbon nanotubes include single-walled carbon nanotubes.

5. The elastomer composition according to claim 1, further comprising a cross-linker.

6. A method of producing an elastomer composition that is a method of producing the elastomer composition according to claim 1, comprising mixing and dispersing a material containing the carbon nanotubes, the elastomer, the organic solvent A, and the organic solvent B.

7. The method of producing an elastomer composition according to claim 6, wherein the mixing and dispersing includes:
mixing the carbon nanotubes, the organic solvent A, and the organic solvent B to obtain a mixture; and
mixing and dispersing the mixture that is obtained and the elastomer.

8. A cross-linked material obtained through cross-linking of the elastomer composition according to claim 1.

9. A shaped object comprising the cross-linked material according to claim 8.
